(19) United States
(12) Patent Application Publication
(10) Pub. No.: US 2019/0202323 A1
(43) Pub. Date: Jul. 4, 2019

(54) Ventilated Seat Cushion for Children

(71) Applicant: GUANGZHOU ZHEXI CREATIVE DESIGN CO., LTD., Guangdong (CN)

(72) Inventor: Guang CHEN, Guangzhou City 510145 (CN)

(73) Assignee: GUANGZHOU ZHEXI CREATIVE DESIGN CO., LTD., Guangdong (CN)

(21) Appl. No.: 16/314,969

(22) PCT Filed: Jul. 5, 2017
(86) PCT No.: PCT/CN2017/091838

§ 371 Date: Jan. 3, 2019

(30) Foreign Application Priority Data
Jul. 7, 2016 (CN) 201620710575.7

(51) Int. Cl. B60N 2/28; B60N 2/56; B61D 33/00

(52) U.S. Cl. CPC B60N 2/2881; B61D 33/0035; B60N 2/565

(57) ABSTRACT

A ventilated seat cushion for children, comprising a seat cushion (1), air inlet holes (3), air outlet holes (4), a centrifugal fan, and a USB power interface (2), the seat cushion (1) being a hollow structure, the centrifugal fan (3) being provided within the seat cushion (1), the surface of the seat cushion (1) being provided with the air inlet holes (3) and the air outlet holes (4); the negative pressure formed when the centrifugal fan is working enables the air to pass through the air inlet holes (3) and to be suctioned into the seat cushion (1), and the high pressure formed when the centrifugal fan is working enables the air within the seat cushion to pass through the air outlet holes (4) and to be blown out, so as to achieve the effect of circulating heat dissipation; and one end of the seat cushion (1) is provided with a crotch belt perforation opening (B) or a crotch belt gap (A) for a five-point seat belt. The ventilated seat cushion for children has a favorable effect of ventilation and cooling, improving the comfort of children when sitting in a trolley or a car safety seat; the ventilated seat cushion for children can not only be used for a children trolley, but can also be used for a car safety seat for children; and providing seat belt perforation opening (B) can improve the safety of children riding in cars.

### TECHNICAL FIELD

The present utility model relates to a ventilated seat cushion for children.

### BACKGROUND ART

In daily life, children will often encounter the situation of sitting in a child trolley, or using a child safety seat, etc. The traditional child trolley seat cushions and safety seat cushions for children are common with poor ventilation and heat dissipation. Especially in summer, buttocks and backs of children often get sweaty or even worse having eczema and other symptoms. While affecting the health of the children, it will further bring hidden security dangers due to the poor self-control of the children and psychological resistance to the seat.

The current available cooling solution for child seat cushions is to put ice mats or cooling mats on the child trolley or the safety seat to alleviate the poor heat dissipation. However, the trolley cushion or the safety seat cushion has sufficient softness and elasticity, causing the ice mat or the cooling mat to be pressed into the cushion by the pressure of the children body and most of the ventilation holes being blocked, thereby reducing the effectiveness of convection heat transfer. Furthermore, the cooling measures such as cooling mats will be completely ineffective when the children's travelling time takes a bit longer.

In the field of automotive supplies, there are ventilated seat cushions for adults which have fans to blow air and form a forced air circulation to cool the buttocks and the back. However, it is not suitable for children because it is designed for adults. For example, the seat cushion for adults is powered by a 12v car Cigar Lighter and cannot be used for a child trolley; its fixing mode is not designed to consider the features of the five-point seat belt of children and is inconvenient for installation.

### Technical Issues

In light of the above-mentioned technical issues, the present utility model is to provide a ventilated seat cushion for children which is suited for solving the discomfort of riding in the scorching weather for children.

### Solutions

### Technical Scheme

The present utility model is realized through the following technical scheme:

A ventilated seat cushion for children, comprising a seat cushion, air inlet holes, air outlet holes, a centrifugal fan, and a USB power interface, the mentioned seat cushion being a hollow structure, the mentioned centrifugal fan being provided within the seat cushion, the surface of the seat cushion being provided with the air inlet holes and the air outlet holes; the negative pressure formed when the centrifugal fan is working enables the air to pass through the air inlet holes and to be suctioned into the seat cushion, and the high pressure formed when the centrifugal fan is working enables the air within the seat cushion to pass through the air outlet holes and to be blown out, so as to achieve the effect of circulating heat dissipation, and one end of the mentioned seat cushion is provided with a crotch belt perforation opening or a crotch belt gap suitable for a five-point seat belt of the child trolley or the child safety seat.

Furthermore, the mentioned USB power interface is rated 5V DC which can be connected to a 5V DC portable power bank or can be connected to a 5V DC vehicle charger for convenience.

Furthermore, the mentioned seat cushion is provided with a support frame in it.

Furthermore, the mentioned seat cushion is provided with several bulges on the surface.

Furthermore, the mentioned seat cushion has suture line on the edge.

Furthermore, the mentioned seat cushion is provided with a skin on the surface.

### BENEFICIAL EFFECTS OF THE PRESENT INVENTION

### Beneficial Effects

Beneficial effects of the present utility model include that:

1. The ventilated seat cushion for children has a favorable effect of ventilation and cooling, improving the comfort of children when sitting in a child trolley or a car safety seat;
2. It not only can be used for a child trolley, but also can be used for a child safety seat;
3. A crotch belt gap or a crotch belt perforation opening for a seat belt is provided to improve the safety of children riding in cars.
4. The surface bulges can be shapes of dots or strips or blocks which functions are to enhance the air flow channel and increase the anti-slip effect of the seat cushion.

### BRIEF DESCRIPTION OF THE DRAWINGS

### Description of the Drawings

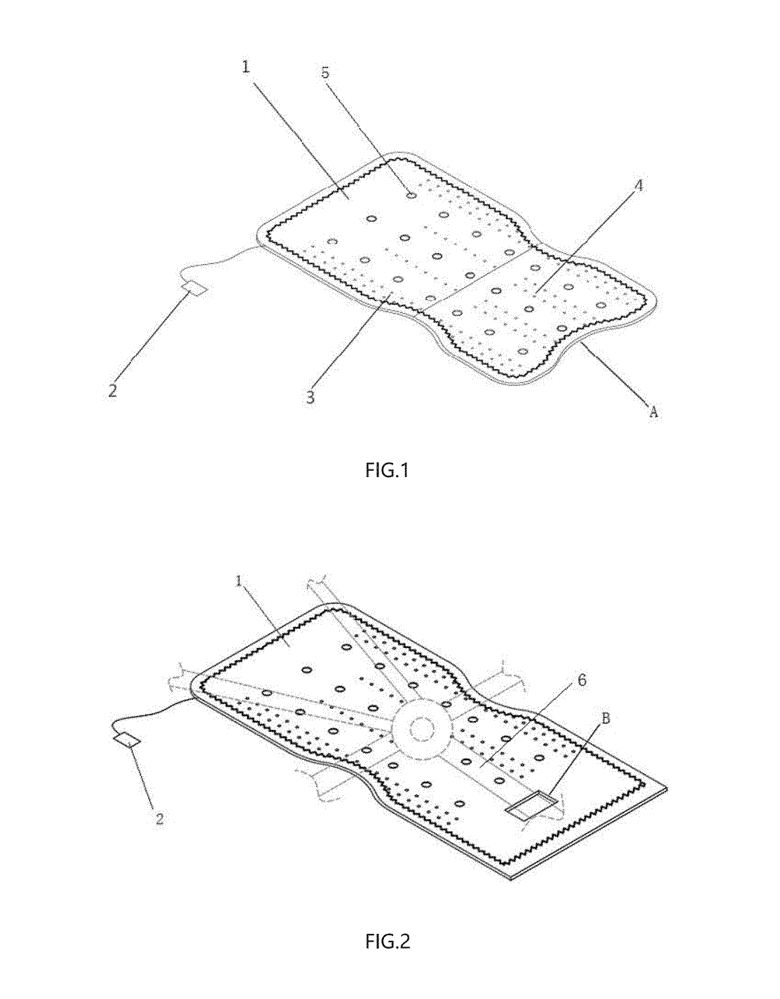

FIG. 1 schematically shows the present utility model, the structural diagram of a crotch belt gap;

FIG. 2 schematically shows the present utility model, the structural diagram of a crotch belt perforation opening.

### SPECIFIC IMPLEMENTATION MODE

### Specific Mode for Carrying Out the Invention

The technical scheme of the present utility model will be clearly and completely described in the following embodiments. Obviously, the described embodiments are only a part of the embodiments of the present utility model, and not all of the embodiments. Based on the embodiments of the present utility model, all other embodiments obtained without creative efforts in this field belong to the scope of protection of the present utility model.

### Embodiment 1

Description of a ventilated seat cushion for children is shown in FIG. 1, comprising a seat cushion (1), air inlet holes (3), air outlet holes (4), a centrifugal fan, and a USB power interface (2), the seat cushion (1) being a hollow structure, the centrifugal fan being provided within the seat cushion (1), the surface of the seat cushion (1) being provided with the air inlet holes (3) and the air outlet holes (4); the negative pressure formed when the centrifugal fan is working enables the air to pass through the air inlet holes (3) and to be suctioned into the seat cushion (1), and the high pressure formed when the centrifugal fan is working enables the air within the seat cushion to pass through the air outlet holes (4) and to be blown out, so as to achieve the effect of circulating heat dissipation; and one end of the seat cushion is provided with a crotch belt gap (A) for a five-point seat belt of the child trolley or the child safety seat.

Furthermore, the mentioned USB power interface is rated 5V DC which can be connected to a 5V DC portable power bank or can be connected to a 5V DC vehicle charger for convenience.

Furthermore, the mentioned seat cushion (1) is provided with the support frame made of plastic or other hard material.

Furthermore, the mentioned seat cushion (1) is provided with several bulges (5) on the surface which is more comfortable and anti-slip.

Furthermore, the mentioned seat cushion has suture line on the edge, making it more good looking.

Furthermore, the mentioned seat cushion surface is provided with a skin which is made of cloth, leather or other materials.

### Embodiment 2

Description of a ventilated seat cushion for children is shown in FIG. 2, comprising a seat cushion (1), air inlet holes (3), air outlet holes (4), a centrifugal fan, and a USB power interface (2), the seat cushion (1) being a hollow structure, the centrifugal fan being provided within the seat cushion (1), the surface of the seat cushion (1) being provided with the air inlet holes (3) and the air outlet holes (4), and one end of the mentioned seat cushion (1) is provided with a crotch belt perforation opening (B) of a five-point seat belt (6) for the belt to be worn, which can be used for the five-point seat belt of the child trolley and the child safety seat.

In the present embodiment, the seat cushion of the present utility model should be placed onto the child trolley or the child safety seat. After being powered, the fan starts working to achieve the effect of ventilation and cooling.

The above-mentioned embodiments are only the specific mode for carrying out the utility model, with specific and detailed description, and cannot be construed as the limitation to the scope of the present utility model. It should be noted that, without deviating from the concept of the present utility model, some changes and modifications may be made by those skilled in this field which are all within the scope of protection of the present utility model.

1. A ventilated seat cushion for children, comprising a seat cushion, air inlet holes, air outlet holes, a centrifugal fan, and a USB power interface, wherein the seat cushion being a hollow structure, the centrifugal fan being provided within the seat cushion, the surface of the seat cushion being provided with the air inlet holes and the air outlet holes; the negative pressure formed when the centrifugal fan is working enables the air to pass through the air inlet holes and to be suctioned into the seat cushion, and the high pressure formed when the centrifugal fan is working enables the air within the seat cushion to pass through the air outlet holes and to be blown out, and one end of the seat cushion is provided with a crotch belt perforation opening or a crotch belt gap for a five-point seat belt.

2. The ventilated seat cushion for children according to claim 1, wherein the seat cushion is charged with a portable power bank.

3. The ventilated seat cushion for children according to claim 1, wherein the seat cushion is provided with a support frame in it.

4. The ventilated seat cushion for children according to claim 1, wherein the seat cushion is provided with a skin on the surface.

5. The ventilated seat cushion for children according to claim 1, wherein the seat cushion is provided with bulges on the surface.
